(19) United States
(12) Patent Application Publication
(10) Pub. No.: US 2025/0047919 A1
(43) Pub. Date: Feb. 6, 2025

(54) METHOD, COMPUTING DEVICE, AND COMPUTER-READABLE STORAGE MEDIUM FOR FACILITATING STREAMER INTERACTION WITH VIEWER

(71) Applicant: 17LIVE JAPAN INC., Tokyo (JP)

(72) Inventors: YUNG-CHI HSU, Taipei City (TW); CHI-WEI LIN, Taipei City (TW); SHAO-TANG CHIEN, Taipei City (TW); WEI-HSIANG HUNG, Taipei City (TW); WEI-KUN LU, Taipei City (TW); YU-CHENG FAN, Taipei City (TW); CHIA-HAN CHANG, Taipei City (TW); HUNG-KUANG TAI, Taipei City (TW)

(21) Appl. No.: 18/420,796

(22) Filed: Jan. 24, 2024

(30) Foreign Application Priority Data
Jul. 31, 2023 (TW) 112128619

(51) Int. Cl. H04N 21/258; H04N 21/2187

(52) U.S. Cl. CPC H04N 21/25891; H04N 21/2187

(57) ABSTRACT

A method for facilitating streamer interaction with a viewer includes extracting a history topic based on an activity record of the viewer; calculating a score of each of the history topics based on at least one parameter; and generating a topic suggestion based on the history topic and the score which is corresponding to the history topic, and providing the topic suggestion to the streamer. The method is suitable for providing a topic suggestion (or interact topic suggestion) with respect to the viewer to the streamer via a live-streaming platform executed by a computing device. Thereby, the method can be used for facilitating streamer interaction with viewers and provides an appropriate topic suggestion. In addition, a computing device and a computer-readable storage medium which are capable of implementing the method are also provided.

### CROSS-REFERENCE TO RELATED APPLICATION

This non-provisional application claims priority under 35 U.S.C. § 119 (a) on Patent Application No(s). 112128619 filed in Taiwan, R.O.C. on Jul. 31, 2023, the entire contents of which are hereby incorporated by reference.

### BACKGROUND OF THE INVENTION

### 1. Field of the Invention

The present disclosure relates to a method, computing device, and computer-readable storage medium for interacting with a viewer, and in particular to a method, computing device, and computer-readable storage medium for helping a streamer host with interacting with a viewer or viewing audience.

### 2. Description of the Related Art

Real-time interaction in the cyberworld, such as live-streaming, has become a popular trend, and the number of viewers and streamers using live streaming services is increasing day by day. In today's live streaming services, streamers usually use at least one live-streaming platform to set up a live-streaming room to interact with the viewers in the live-streaming room in real time. Streamers will try to interact with their viewers to increase their favorability, and for that, streamers will need to try to find suitable topics. However, the streamer can often only decide on the topic based on the basic data filled in by the viewer in advance or the response given by the viewer to the streamer, which creates a gap between the streamer and the viewer, making it impossible for the streamer to switch to the appropriate topic in a timely manner and interact with the viewer in real time.

In addition, although some live-streaming platforms are committed to recording more information about the viewers and providing more information about the viewers to the streamers, they still need to rely on the streamers' own experience to have the opportunity to find a suitable topic from the existing information to interact with the viewers in real time.

### BRIEF SUMMARY OF THE INVENTION

Based on the above, an object of the present disclosure is to solve the deficiencies of the prior art. Specifically, one object of the present disclosure is to solve the problem that streamers are unable to interact with the viewers in real time through suitable topic suggestions. Another object of the present disclosure is to solve the problem of determining when the suitable topic suggestions need to be generated.

The present disclosure provides a method for helping a streamer interact with a viewer, which is suitable for providing a topic suggestion with respect to the viewer to the streamer via a live-streaming platform executed by a computing device. The method includes extracting a historical topic based on an activity record of the viewer; calculating a score of each of the historical topics based on at least one parameter; and generating a topic suggestion based on the historical topic and the score corresponding to the historical topic, and providing the topic suggestion to the streamer.

In some embodiments, generating the topic suggestion based on the historical topic and the score corresponding to the historical topic may include calculating a threshold of the streamer based on the level of the streamer; calculating a real-time engagement score of the viewer in real time based on at least one real-time parameter; comparing the real-time engagement score with the streamer's threshold; generating a topic suggestion based on the historical topic and the score corresponding to the historical topic when the real-time engagement score is less than the streamer's threshold; and generating a current topic as the topic suggestion or no topic suggestion based on the current interactive content of the streamer when the real-time engagement score is greater than or equal to the streamer's threshold.

In some embodiments, the historical topic is a first historical, which is configured to be extracted based on a first interaction record between the viewer and the streamer; the score is a first engagement score, which is configured to be calculated based on at least one first interaction parameter between the viewer and the streamer; and the topic suggestion is a first topic, which is configured to be generated based on the first historical topic and the first engagement score corresponding to the first history topic.

In some embodiments, the historical topic is a second historical topic, which is configured to be extracted based on a second interaction record between the viewer and other streamers. The score is a second engagement score, which is configured to be calculated based on at least one second interaction parameter between the viewer and other streamers. The topic suggestion is a second topic, which is configured to be generated based on the second historical topic and the second engagement score corresponding to the second historical topic.

In some embodiments, the historical topic includes a first historical topic and a second historical topic, the first historical topic is configured to be extracted based on a first interaction record between the viewer and the streamer, and the second historical topic is configured to be extracted based on a second interaction record between the viewer and other streamers. The score includes a first engagement score and a second engagement score. The first engagement score is configured to be calculated based on at least one first interaction parameter between the viewer and the streamer, and the second engagement score is configured to be calculated based on at least one second interaction parameter between the viewer and other streamers. The topic suggestion includes a first topic and a second topic, the first topic is configured to be generated based on the first historical topic and the first engagement score corresponding to the first historical topic, and the second topic is configured to be generated based on the second historical topic and the second engagement score corresponding to the second historical topic.

In some embodiments, the method for facilitating streamer interaction with the viewer provided by the present disclosure may further include judging whether the viewer is a new viewer of the streamer, and if the viewer is not a new viewer of the streamer, the first topic is adopted as the topic suggestion. If the viewer is a new viewer of the streamer, the first topic or the second topic is selectively adopted as the topic suggestion.

In some embodiments, selectively adopting the first topic or the second topic as the topic suggestion may include based on an interaction duration between the viewer and the streamer, respectively calculating a weight value corresponding to the first topic and a weight value corresponding to the second topic. Based on the weight value corresponding to the first topic and the weight value corresponding to the second topic, selectively adopting the first topic or the second topic as the topic suggestion.

In some embodiments, the method for facilitating streamer interaction with the viewer provided by the present disclosure may further include analyzing a change in the score corresponding to the topic suggestion when the streamer adopts the topic suggestion to interact with the viewer.

In some embodiments, the method for facilitating streamer interaction with the viewer provided by the present disclosure may further include calculating a distribution of each topic suggestion based on the topic suggestions of a plurality of viewers in the live streaming of the streamer, and generating an overall topic suggestion based on the distribution, and the overall topic suggestion is provided to the streamer.

The present disclosure also provides a computing device for facilitating streamer interaction with the viewer, which is suitable for providing a topic suggestion, with respect to the viewer, to the streamer in a live-streaming platform. The computing device includes at least one processing unit and at least one storage unit, the at least one storage unit stores a code, wherein after executing the code, the at least one processing unit is capable of executing the steps of the method for facilitating streamer interaction with the viewer as described above.

The present disclosure also provides a computer-readable storage medium for facilitating streamer interaction with the viewer, wherein, after a computer loads a code stored in the computer-readable storage medium and executes it, the above-described method for facilitating streamer interaction with the viewer is capable of being achieved.

The technical means provided by the present disclosure may produce beneficial effects that cannot be achieved by the prior art. Specifically, one of the beneficial effects of the present disclosure is to generate a suitable topic suggestion, and the streamer interacts with the viewers in real time through the suitable topic suggestion, and another beneficial effect of the present disclosure is to determine when a suitable topic suggestion needs to be generated.

### BRIEF DESCRIPTION OF THE DRAWINGS

FIG. 1 is a schematic view illustrating a transmitter interacting with viewers through a live-streaming platform executed by a computing device such as a server and via a network according to an embodiment of the present disclosure.

FIG. 2 is a block diagram illustrating the functions and constituent elements of a user terminal according to an embodiment of the present disclosure.

FIG. 3 is a block diagram illustrating the functions and constituent elements of a computing device such as a server according to an embodiment of the present disclosure.

FIG. 4A is a schematic view illustrating the data stored in the streaming database according to an embodiment of the present disclosure.

FIG. 4B is a schematic view illustrating the data stored in the user database according to an embodiment of the present disclosure.

FIG. 4C is a schematic view illustrating the data stored in the gift database according to an embodiment of the present disclosure.

FIG. 4D is a schematic view illustrating the data stored in the historical response database according to an embodiment of the present disclosure.

FIG. 4E is a schematic view illustrating the data stored in the parameter database according to an embodiment of the present disclosure.

FIG. 4F is a schematic view illustrating the data stored in the topic score database according to an embodiment of the present disclosure.

FIG. 5 is a flowchart illustrating the method for facilitating streamer interaction with viewers according to an embodiment of the present disclosure.

FIG. 6 is a schematic view illustrating recording data in a time-series manner according to an embodiment of the present disclosure.

FIG. 7 is a schematic view illustrating the display of a topic suggestion on a user interface according to an embodiment of the present disclosure.

FIG. 8 is a flow chart illustrating the method for facilitating streamer interaction with the viewers according to an embodiment of the present disclosure.

FIG. 9 is a time series diagram illustrating the relative relationship between the viewer's score and the streamer's threshold according to an embodiment of the present disclosure.

FIG. 10 is a flow chart illustrating the method for facilitating streamer interaction with the viewers according to an embodiment of the present disclosure.

FIG. 11 is a flow chart illustrating the method for facilitating streamer interaction with the viewers according to an embodiment of the present disclosure.

FIG. 12 is a flow chart illustrating the method for facilitating streamer interaction with the viewers according to an embodiment of the present disclosure.

FIG. 13 is a flow chart illustrating the method for facilitating streamer interaction with the viewers according to an embodiment of the present disclosure.

FIG. 14 is a schematic view illustrating the display of the topic suggestion on the user interface according to an embodiment of the present disclosure.

### DETAILED DESCRIPTION OF THE INVENTION

The present disclosure will be described in detail by the following embodiments and accompanying drawings, thereby helping a person having ordinary knowledge in the art of the present disclosure to understand the object, features, and effects of the present disclosure. It should be noted that the steps described herein may be performed sequentially, in reverse order, or by appropriately changing or skipping the order during the control process. Further, in the content of the present disclosure, terms such as “first”, “second”, and “third” are used to distinguish differences between elements, not to limit the element itself or to indicate a particular order of the elements.

Before the present disclosure is described in detail, it should be noted that the same element or step may be indicated by the same number in the following description.

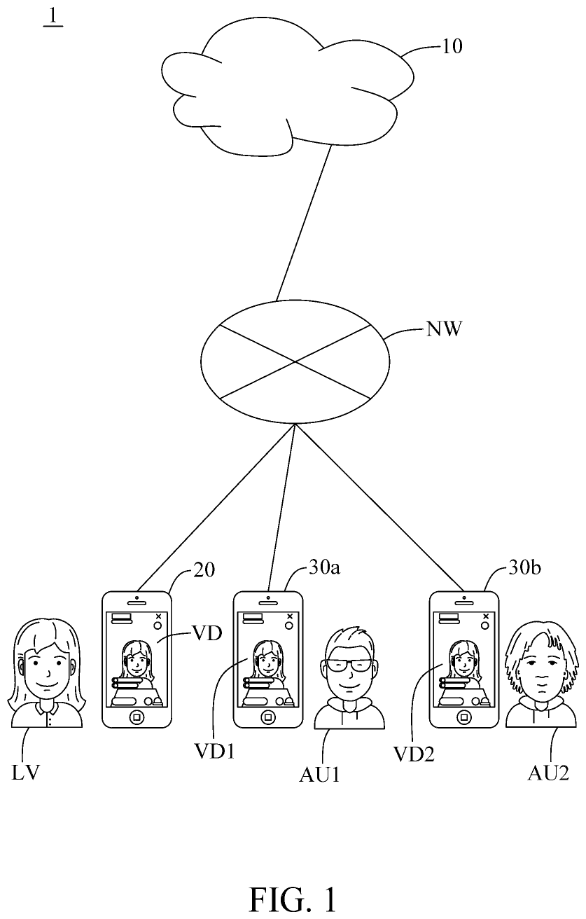

Refer to FIG. 1, which is a schematic view illustrating a transmitter LV interacting with viewers AU1 and AU2 through a live-streaming platform executed by a computing device such as a server 10 and via a network NW according to an embodiment of the present disclosure. FIG. 1 may also be described as a live transmission system 1.

The live transmission system 1 provides a two-way live transmission service that a transmitter (such as a host, anchor, streamer, or live streamer, etc.) LV and viewers (also called audience) AU (AU1, AU2 . . . ) can interact in real time on a live platform (also known as a live-streaming platform or live-streaming room) via a network NW. As shown in FIG. 1, the live transmission system 1 may have a computing device such as a server 10, a user terminal 20 of a transmitter LV, and user terminals 30 (30a, 30b . . . ) of viewers AU (AU1, AU2 . . . ). The transmitter LV and the viewers AU (AU1, AU2 . . . ) may also be collectively referred to as users. The server 10 may be a physical server composed of one or more information processing devices connected to the network NW, but is not limited thereto. The user terminals 20, 30 (30a, 30b . . . ) may not only be portable terminals, such as smartphones, tablets, portable personal computers, recorders, portable game consoles, or wearable devices, but may also be fixed devices, such as desktop personal computers. The server 10 and the user terminals 20, 30 (30a, 30b . . . ) may communicate with each other through various wired or wireless networks NW, so that the server 10 and the user terminals 20, 30 (30a, 30b . . . ) can transfer data to each other through the network NW. The wired network NW may refer to a wired network connection established through a physical signal line such as Cat.6 or optical fiber, so that it can send and/or receive instructions and/or data via the wired network connection. The wireless network NW may refer to a wireless network connection established through such as a Wi-Fi sharing router, so that it can send and/or receive instructions and/or data via a wireless network connection.

The transmitter LV, viewers AU (AU1, AU2 . . . ) and the administrator responsible for managing the server 10 (not shown) may engage in the live transmission system 1. The transmitter LV may refer to a user who uses his own user terminal 20 to record and/or video live contents such as his own songs, speeches, performances, divination, or games, and upload the contents directly to the server 10 via the network NW, thereby sending the content in real time. The administrator provides a live platform for transmitting the contents live in the server 10, and at the same time, adjusts and/or manages the real-time interaction between the transmitter LV and viewers AU (AU1, AU2 . . . ). The viewers AU (AU1, AU2 . . . ) may refer to users who use their own user terminals 30 (30a, 30b . . . ) to enter the live platform and select the desired content to watch. When the content is transmitted live, the viewers AU (AU1, AU2 . . . ) can perform operations such as messages, solidarity, or gift-giving through the user terminals 30 (30a, 30b . . . ). The transmitter LV providing the content may respond to operations such as messages, solidarity, or gift-giving, and the response may be transmitted to the viewers AU (AU1, AU2 . . . ) through images and/or sound, thereby establishing two-way instant messaging.

In the present disclosure, “live transmission” refers to the form of transmission of data. The form of transmission of data may refer to a state that the content recorded and/or videoed by using the user terminal 20 of the transmitter LV is substantially played or displayed on the user terminals 30 (30a, 30b . . . ) of the viewers AU (AU1, AU2 . . . ) in real time and becomes audiovisual, or refers to the transmission itself through the transmission form described above. The live transmission may be achieved using live transmission technologies such as HTTP Live Streaming, Common Media Application Format, Web Real-Time Communications, Real-Time Messaging Protocol, or MPEG DASH, but is not limited thereto. The live transmission may include the form of transmission described below. When the transmitter LV records and/or videos the content, the viewers AU (AU1, AU2 . . . ) may watch the content simultaneously with a scheduled or fixed delay. As for the size of the delay (i.e., the amount of time delayed), it may be the amount of delay at least enough to allow that the degree of interaction between the transmitter LV and the viewers AU (AU1, AU2 . . . ) is established. However, the live transmission is distinguished from the so-called on-demand transmission. Specifically, in the on-demand transmission, the data of the entire recording and/or videoing content is temporarily stored in the server 10, and the data is provided to the user from the server 10 at any time point after the completion of storage according to the request of the user.

In the present specification, “audio-visual data” is a data including a series of image data (may also be referred to as video data) generated by the shooting function of the user terminals 20, 30 (30a, 30b . . . ) and the sound data (also known as audio data) generated by the sound input function of the user terminals 20, 30 (30a, 30b . . . ). By playing video data on the user terminals 20, 30 (30a, 30b . . . ), the users can watch the content through the user terminals 20, 30 (30a, 30b . . . ). In the present embodiment, it is envisaged that data processing of changing the form, size, or specification of the data (e.g., compression, decompression, encoding, decoding, transcoding, but not limited thereto) will be performed during the period from generating the audio-visual data on the user terminal 20 of the transmitter LV until playing the audio-visual data on the user terminals 30 (30A, 30B . . . ) of the viewers AU (AU1, AU2 . . . ). The content represented by the audio-visual data (e.g., dynamic images, sounds) before and after the data processing does not change substantially. In an embodiment, it will be described assuming that the audio-visual data after the data processing is the same as the audio-visual data before the data processing, i.e., if the audio-visual data is generated on the user terminal 20 of the transmitter LV, and then played on the user terminals 30 (30a, 30b . . . ) of the viewers AU (AU1, AU2 . . . ) through the server 10, the audio-visual data generated on the user terminal 20 of the transmitter LV, the audio-visual data transmitted through the server 10, and the audio-visual data received and played on the user terminals 30 (30a, 30b . . . ) of the viewers AU (AU1, AU2 . . . ) are the same audio-visual data.

The user terminals 30 (30a, 30b . . . ) of the viewers AU (AU1, AU2 . . . ) who requests the live platform for watching the live transmission of the transmitter LV respectively receive the audio-visual data related to the live transmission through the network NW, and display the dynamic images VD1 and VD2 on the display of the user terminals 30 (30a, 30b . . . ) of the viewers AU (AU1, AU2 . . . ) by playing the received audio-visual data, and at the same time, the sound is output through the speaker. The dynamic images VD1, VD2 displayed in each of the user terminals 30 (30a, 30b . . . ), and the dynamic image VD captured by the user terminal 20 of the transmitter LV are substantially the same, the sound output in each of the user terminals 30 (30a, 30b . . . ) is also substantially the same as the sound recorded by the user terminal 20 of the transmitter LV.

Substantially, recording and/or videoing on the user terminal 20 of the transmitter LV and playing the audio-visual data on the user terminals 30 (30a, 30b) of the viewers AU (AU1, AU2 . . . ) are simultaneously carried out. As far as the content provided by the transmitter LV is concerned, when a viewer AU1 inputs a message to the user terminal 30a, the server 10 will display the message in real time on the user terminal 20 of the transmitter LV, and also display the message on the user terminals 30 (30a, 30b) of each of the viewers AU (AU1, AU2 . . . ). When the transmitter LV reading the information unfolds a conversation covering the message, the dynamic image and sound of the conversation may be output to the user terminals 30 (30a, 30b) of each of the viewers AU (AU1, AU2 . . . ), thereby identifying the dialogue between the transmitter LV and the viewers AU (AU1, AU2 . . . ) is established. Thus, the live transmission system 1 can achieve the live transmission of two-way communication rather than the live transmission of one-way communication, in particular, two-way instant communication can be achieved.

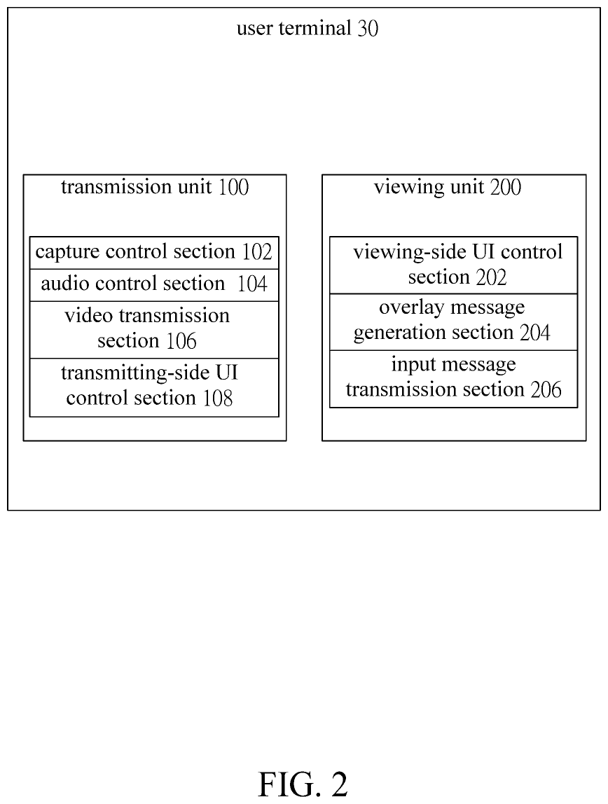

Refer to FIG. 2, which is a block diagram illustrating the functions and constituent elements of a user terminal 30 according to an embodiment of the present disclosure. The user terminal 20 may have the same functions and composition as the user terminal 30. Each of the boxes shown in the block diagram of FIG. 2 can be executed by elements led by the computer CPU or mechanical devices in terms of hardware, and by computer code or instruction sets in terms of software, and the functional modules achieved by their cooperation are drawn here. Therefore, a person having ordinary knowledge in the art to which the present disclosure belongs can understand that these functional modules may be implemented in various forms by a combination of hardware and software.

The transmitter LV and viewers AU may download and install a live transmission application (hereinafter referred to as a live transmission application) related to the present embodiment from the website via the network NW to the user terminals 20, 30 (30a, 30b . . . ). Alternatively, the live transmission application may be installed in advance on the user terminals 20, 30 (30a, 30b . . . ). After executing the live transmission application through the user terminals 20, 30 (30a, 30b . . . ), the user terminals 20, 30 (30a, 30b . . . ) may communicate with the server 10 via the network NW to execute various functions. In the following, the functions implemented by the user terminals 20, 30 (30a, 30b . . . ) (for example, a processor such as a CPU) executing the live transmission application are regarded as the functions of the user terminals 20, 30 (30a, 30b . . . ) that is explained. These functions are actually functions that the live transmission application can implement in the user terminals 20, 30 (30a, 30b . . . ). It should be noted that, in other embodiments, these functions may be also be implemented by a computer program, the computer program may be a web browser sent from the server 10 to the user terminals 20, 30 (30a, 30b . . . ) via the network NW, and a programming language such as hypertext markup language (Hyper Text Markup Language (HTML)) is used to describe, the programming language can be executed by a web browser.

The user terminal 30 may have a transmission unit 100 and a viewing unit 200, wherein the transmission unit 100 may be configured to generate audio-video data recording the user's image and sound, and the generated audio-video data is transmitted to the server 10, and the viewing unit 200 may be configured to acquire and play the audio-video data from the server 10. The user starts the transmission unit 100 when transmitting the audio-video data, and starts the viewing unit 200 when viewing the audio-video data. The user terminal started by the transmission unit 100 may be regarded as the transmitter side, that is, the user terminal of the generation side of the audio-video data. The user terminal started by the viewing unit 200 may be regarded as the viewer side, that is, the user terminal of the playing side of the audio-video data.

The transmission unit 100 may include a capture control section 102, an audio control section 104, a video transmission section 106 and a transmitting-side UI control section 108. The capture control section 102 can be connected with a photographic lens (not shown in FIG. 2) to control the camera for shooting, and the capture control section 102 can obtain image data from the photographic lens. The audio control section 104 can be connected with a microphone (not shown in FIG. 2) to control the input of the sound received by the microphone, and the audio control section 104 can obtain sound data from the microphone. The video transmission section 106 can transmit audio-visual data to the server 10 via a network NW, and the audio-visual data may include image data obtained by the capture control section 102 and sound data obtained by the audio control section 104. The video transmission section 106 can transmit audio-visual data instantly, that is, the audio-visual data generated by the capture control section 102 and the audio control section 104 and the audio-visual data generated by transmitting through the video transmission section 106 are basically executed simultaneously. The transmitting-side UI control section 108 can control the user interface (UI) for the transmitter. The transmitting-side UI control section 108 can be connected with a display (not shown in FIG. 2) to display dynamic images VD (VD1, VD2 . . . ) on the display by playing the audio-visual data transmitted by the video transmission section 106. The transmitting-side UI control section 108 can display the object of operation and the object of receiving instructions on the display, and accept the click and input of the transmitter.

The viewing unit 200 may include a viewing-side UI control section 202, an overlay message generation section 204 and an input message transmission section 206. The viewing unit 200 can receive the audio-visual data related to the live transmission in which the transmitter LV, the user of the user terminal 30, namely the viewer AU and other viewers AU1, AU2 engage through the network NW from the server 10. The viewing-side UI control section 202 can control the UI for the viewers. The viewing-side UI control section 202 can be connected with a display (not shown in FIG. 2) and a speaker (not shown in FIG. 2) respectively, and dynamic images are displayed on the display by playing the received audio-video data, and the sound is output by the speaker at the same time. The process of displaying images on a display and outputting sound from a speaker can be referred to as “playing audio-video data”. The viewing-side UI control section 202 is connected to input units such as a touch panel or keyboard (not shown in FIG. 2) through which the user's input content is obtained. The overlay message generation section 204 can superimpose the images of the audio-visual data obtained from the server 10 on a predetermined frame image. The frame image may include various user interface objects or user interface articles (hereinafter referred to as objects) used to accept a user's input, the message input by the viewers AU (AU1, AU2 . . . ) and the message obtained from the server 10. The input message transmission section 206 can transmit the user input obtained by the viewing-side UI control section 202 to the server 10 through the network NW.

The viewing-side UI control section 202 can accept the message input by viewers AU (AU1, AU2 . . . ) during live transmission through the input unit. As mentioned above, the message may be a public message that can be read not only by the viewer AU and the transmitter LV who input it, but also by the other viewers AU1 and AU2 who engage in the live transmission.

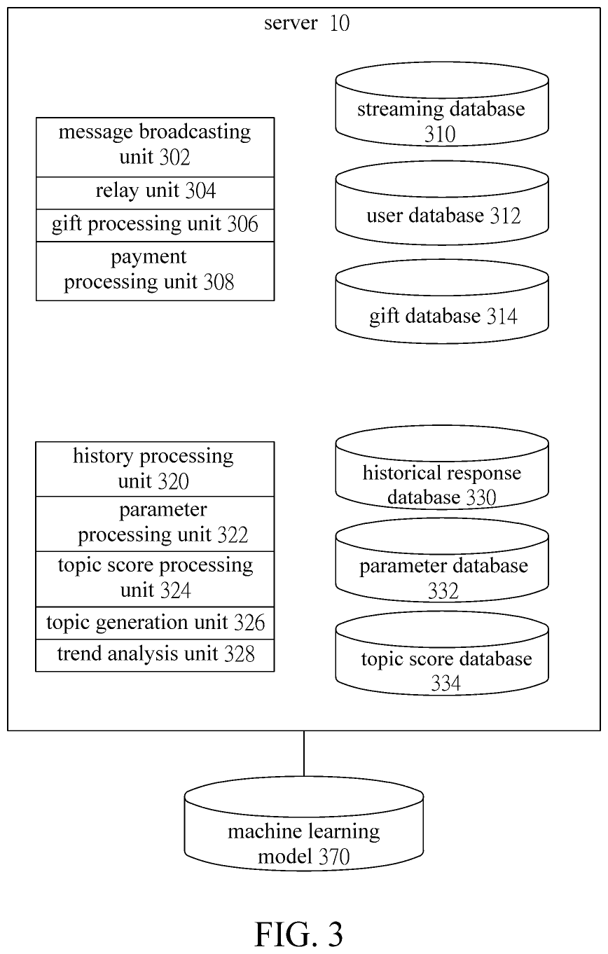

Refer to FIG. 3, which is a block diagram illustrating the functions and constituent elements of a computing device such as a server 10 according to an embodiment of the present disclosure. The server 10 may have a message broadcasting unit 302, a relay unit 304, a gift processing unit 306, a payment processing unit 308, a streaming database 310, a user database 312, a gift database 314, a history processing unit 320, a parameter processing unit 322, a topic score processing unit 324, a topic generation unit 326, a trend analysis unit 328, a historical response database 330, a parameter database 332 and a topic score database 334. The server 10 can communicate with a machine learning model 370.

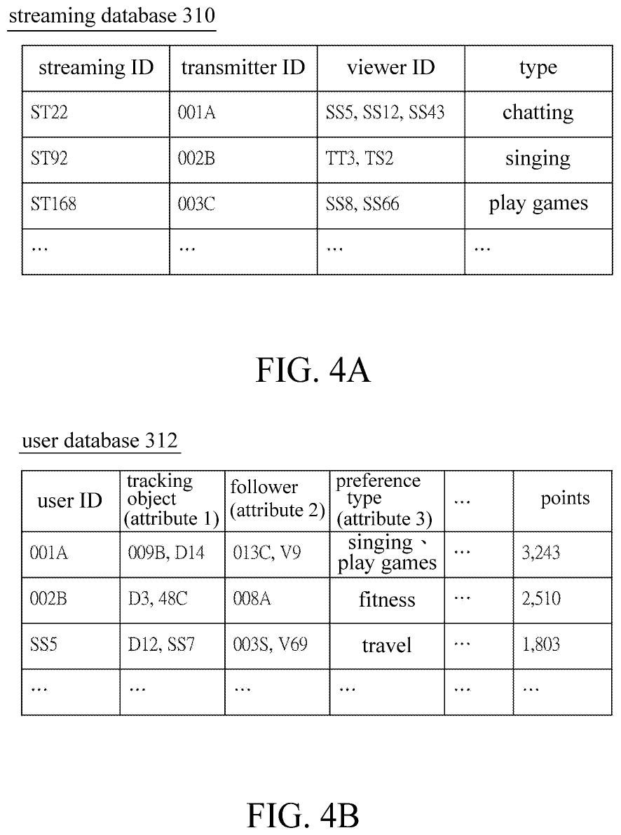

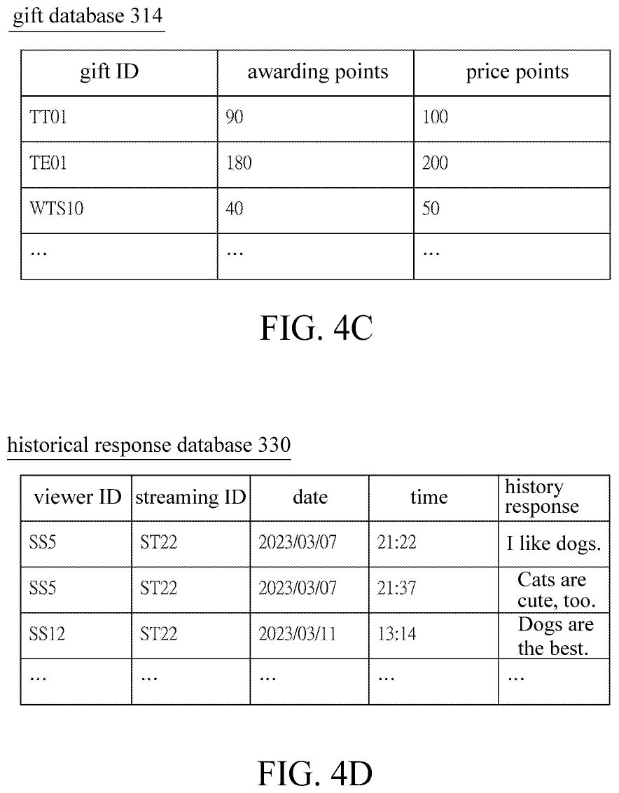

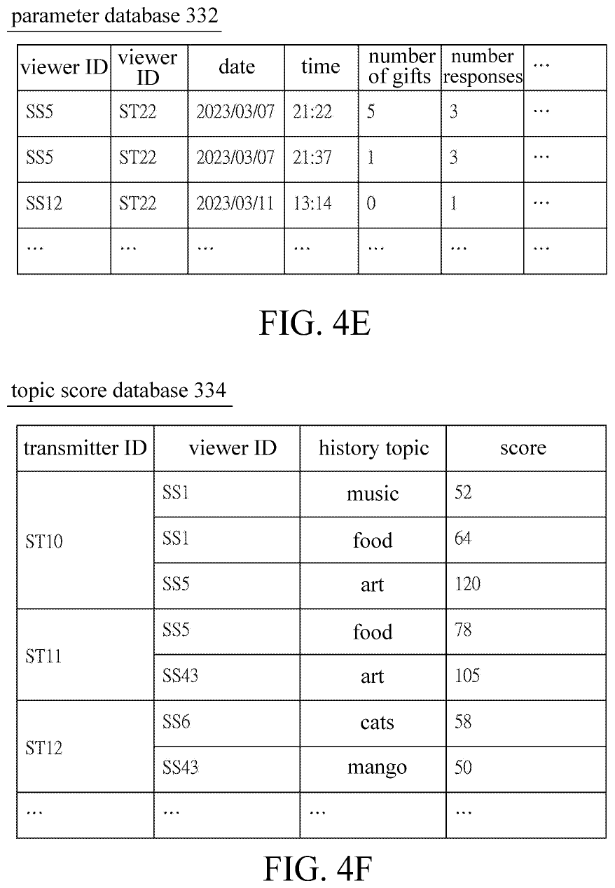

When a notification or request is received from the user terminal 20 of the transmitter LV to start a live streaming service via the network NW, the message broadcasting unit 302 registers a streaming ID for identifying the live streaming service and a transmitter ID of the transmitter executing the live streaming service in the streaming database 310, and the streaming ID and the transmitter ID may be respectively recorded in the streaming database 310. A detailed description of the streaming database 310 is described further with reference to FIG. 4A.

When the message broadcasting unit 302 receives a request to provide message about the live streaming service from the viewing unit 200 of the user terminal 30 of the viewer AU through the network NW, the message broadcasting unit 302 may extract or check the currently available live streaming service from the streaming database 310 and make a form of the available live streaming service. The message broadcasting unit 302 can transmit the resulting form to the user terminal 30 that makes the request through the network NW. The viewing-side UI control section 202 of the user terminal 30 that makes the request will generate a live streaming service selection screen based on the received form and display it on the display screen of the user terminal 30.

Once the input message transmission section 206 of the user terminal 30 receives the viewer's selection result on the live streaming service selection screen, the input message transmission section 206 can generate a distribution request including the streaming ID of the selected live streaming service, and the distribution request is transmitted to the server 10 through the network NW. The message broadcasting unit 302 begins to provide the user terminal 30 that makes the request with a live streaming service specified by the streaming ID included in the received distribution request. The message broadcasting unit 302 may update the streaming database 310 to record the user ID of the viewer AU of the user terminal 30 that makes the request as a viewer ID belonging to (or corresponding to) the streaming ID.

The relay unit 304 can forward audio-visual data from the user terminal 20 of the transmitter LV to the user terminal 30 of the viewer AU in the live streaming started by the message broadcasting unit 302. The relay unit 304 can receive a signal input by the user terminal 30 of the viewer AU during the reproduction (or regeneration, or copying) of the audio-visual data (or during the live streaming) from the input message transmission section 206. The signal input by the user terminal 30 may be an object-specified signal for specifying the object displayed on the display of the user terminal 30. The object-specified signal may include the viewer ID of the viewer AU, the transmitter ID of the live streaming service watched by the viewer, and the object ID of the identifying object. In an example, when the object is a gift, the object ID is the gift ID. Similarly, the relay unit 304 may receive a signal from the user terminal 20 that represents user input executed by the transmitter LV during the reproduction of the audio-visual data (or during the live streaming). The signal may be a specified signal of an object, but is not limited thereto.

The gift processing unit 306 may update the user database 312 to increase the points of the transmitter LV based on the points of the gift determined by the gift ID included in the object-specified signal. Specifically, the gift processing unit 306 will refer to the data stored in the gift database 314, in order to specify the corresponding points to be awarded for the gift ID included in the received object-specified signal. Further, the gift processing unit 306 may update the user database 312 to add the determined points to the points of the transmitter ID included (or corresponding to) in the object-specified signal. Specific descriptions of the user database 312 and the gift database 314 will be further described with reference to FIGS. 4B and 4C, respectively.

The payment processing unit 308 may respond to the received object-specified signal to process the payment of gift price from the viewers AU (AU1, AU2 . . . ). Specifically, the payment processing unit 308 may refer to the data stored in the gift database 314 to specify the price points of the gift identified by the gift ID included in the object-specified signal. Further, the payment processing unit 308 may update the user database 312, so that the specified price points are subtracted from the points identified by the viewer AU and identified by the viewer ID included in the object-specified signal.

The history processing unit 320 can receive message input by the user terminal 30 (30a, 30b . . . ) of the viewers AU (AU1, AU2 . . . ), and the message can be stored in a historical response database 330. In addition, the history processing unit 320 may also extract or check the data previously stored in the historical response database 330 after receiving a request from the server 10, and then perform history data processing on the data stored in the historical response database 330. The history data processing may include data screening (e.g., screening out a specific viewer's response record from the historical response database 330) and data sorting (e.g., sorting a specific viewer's response record by time series), etc., but is not limited thereto. A detailed description of the historical response database 330 will be further described with reference to FIG. 4D.

The parameter processing unit 322 may record the user's activity situation as a parameter in the parameter database 332, wherein the parameter (i.e., the user's activity situation) may include the number of giving gifts, the number of tokens used, the number of responses, the tracking behavior, and the sharing behavior, etc., but is not limited thereto. In addition, the parameter processing unit 322 may extract or check the data previously stored in the parameter database 332 from the parameter database 332 after receiving a request made by the server 10, and then perform parameter data processing on the data stored in the parameter database 332. The parameter data processing may include data screening (e.g., screening out a specific viewer's parameter from the parameter database 332), data sorting (e.g., sorting the parameter of a specific viewer by time series or the weight value of each parameter) and weighting operation (e.g., assigning corresponding weight values to each parameter, and then making weighting calculations according to the parameters and their corresponding weight values), etc., but is not limited thereto. A detailed description of the parametric database 332 will be further described with reference to FIG. 4E.

The topic score processing unit 324 can respectively receive data that has been processed from the history processing unit 320 and the parameter processing unit 322. Specifically, the topic score processing unit 324 can receive message that has been processed from the history processing unit 320, and can receive the parameters that have been processed from the parameter processing unit 322. After receiving the data that has been processed, the topic score processing unit 324 may process the data including capturing history topics (e.g., capturing the corresponding topics for each message that has been processed) and awarding corresponding scores (e.g., scoring each topic in the history respectively based on the parameters that have been processed), but is not limited thereto. In addition, the topic score processing unit 324 can respectively record the scores corresponding to the completed topics in the history and the awarded corresponding scores in the topic score database 334. A detailed description of the topic score database 334 will be further described with reference to FIG. 4F.

The topic generation unit 326 can directly receive the data that has been processed from the topic score processing unit 324, which includes history topics and scores, and then produces the topics suitable for the viewers AU (AU1, AU2 . . . ) for the reference of the transmitter LV. In some embodiments, the topic generation unit 326 may also obtain the required data from the topic score database 334, which includes topic history and scores, and then produces the topics suitable for the viewers AU (AU1, AU2 . . . ) for the reference of the transmitter LV. In addition, the topic generation unit 326 can produce the topics suitable for the viewers AU (AU1, AU2 . . . ) based on the topic history and scores stored in the topic score database 334 after the transmitter LV makes a request to the server 10 through the network NW. A topic suggestion generated by the topic generation unit 326 can be transmitted to the user terminal 20 of the transmitter LV through the network NW, and can be displayed on the user terminal 20 of the transmitter LV. In addition, the topic suggestion generated by the topic generation unit 326 can be stored in the topic suggestion database (not shown in FIG. 3).

The trend analysis unit 328 can directly receive a topic suggestion from the theme generation unit 326 (or from the topic suggestion database), and then determine whether the current or subsequent content of the transmitter LV is the same as the topic suggestion, and when the transmitter LV accepts and adopts the topic suggestion, a change in the score corresponding to the topic suggestion is further evaluated. In some embodiments, the trend analysis unit 328 may also decide whether the topic generation unit 326 is required to make a request to regenerate a new topic suggestion based on the change in the score corresponding to the topic suggestion. In other embodiments, the trend analysis unit 328 may also decide whether to first make a request to the topic score processing unit 324 to recalculate the score corresponding to the same history topic as the topic suggestion, and then make a request to the topic generation unit 326 to regenerate a new topic suggestion based on the change in the score corresponding to the topic suggestion. In addition, after evaluating the changes in the scores corresponding to the topic suggestion, the trend analysis unit 328 may record the changes in the trend analysis database (not shown in FIG. 3). The change may include no significant change, a significant increase, or a significant decrease, and may be defined by the slope of change of the score, for example, but is not limited thereto. In some embodiments, the change may also be displayed and/or recorded in numerical form.

The machine learning model 370 can be a machine learning database that includes one or more machine learning models. The machine learning model 370 can communicate with the server 10. In some embodiments, the machine learning model 370 may also be implemented within the server 10. The machine learning model 370 may include or utilize machine learning algorithms, such as supervised learning algorithms, unsupervised learning algorithms, reinforcement learning algorithms, or gradient boosting algorithms, can achieve LightGBM (light gradient boosting machine), and/or can achieve decision tree algorithms.

Refer to FIG. 4A, which is a schematic view illustrating the data stored in the streaming database 310 according to an embodiment of the present disclosure. The streaming database 310 can be used to store messages of the live transmission that are currently performed. Specifically, in some embodiments, the streaming database 310 may store the following in association with each other, such as streaming IDs, transmitter IDs, viewer IDs, and types, but is not limited thereto.

The streaming ID may refer to the identification code that determines the live transmission in the live platform provided by the live transmission system 1 (or may also be the live-streaming room ID of the live streamer). The transmitter ID may refer to the identification code of the user that determines the transmitter of the live transmission (or may be the live streamer ID). The viewer ID may refer to the identification code of the user that determines the viewer of the live transmission (or may be the audience ID). The type may refer to the topic category during the live transmission (e.g., the topic category in the live-streaming room). In the live platform provided by the live transmission system 1 related to the present disclosure, when the user carries out the live transmission, the user who transmits the live content is the transmitter LV. When the same user is watching the live content transmitted by another user, the same user who receives the live content becomes the viewer AU. Therefore, the distinction between the transmitter LV and the viewer AU is not fixed, that is, the same user may be identified as the transmitter LV or the viewer AU respectively in different usage scenarios. The type can be specified when the transmitter LV starts transmitting the live content. In some embodiments, the type can also be automatically judged by a machine learning model 370 in the server 10. In some embodiments, the relationship between the transmitter ID and the streaming ID may be one-to-many, that is, the same transmitter ID may correspond to a number of different streaming IDs, but each streaming ID corresponds to only one transmitter ID.

Refer to FIG. 4B, which is a schematic view illustrating the data stored in the user database 312 according to an embodiment of the present disclosure. The user database 312 can be used to store messages related to the user. Specifically, in some embodiments, the user database 312 may store the following in association with each other: user ID, tracking object, follower, preference type, and points, etc., but is not limited thereto.

The user ID may refer to an identification code that determines the user. The tracking object (i.e., the object tracked by the user) may refer to the identification code of other users tracked by using the tracking function. The follower (i.e., the object by which the user is tracked) may refer to the identification code of other users who track the user. The preference type may be specified by the user, and in some embodiments, the preference type may also be automatically judged by a machine learning model 370 in the server 10. The points may refer to the points owned, obtained, or accumulated by the user, and can have an electronic value in circulation in the live platform. In the live transmission, when the viewer AU gives a gift to the transmitter LV, the points of the user ID of the transmitter LV will be increased by the value corresponding to the gift. In some embodiments, the points may be used to determine the rewards or amounts that the transmitter LV receives from the administrator of the live platform, but are not limited thereto. In addition, in some embodiments, when the viewer AU gives a gift to the transmitter LV, the amount equivalent to the gift is given to the transmitter LV, instead of points. The data stored in the user database 312 may also include the time spent using the live platform, with basic user data such as age, gender, and place of residence, as well as types or topics that the user does not like.

Refer to FIG. 4C, which is a schematic view illustrating the data stored in the gift database 314 according to an embodiment of the present disclosure. The gift database 314 may be used to store data related to gifts that can be used by viewers in the live transmission.

The gift may be electronic data with the following characteristics:

The gifts can be purchased with points or money, or the gifts can be given for free.

The viewer AU is able to give gifts to the transmitter LV. The act of giving a gift to the transmitter LV can also be referred to as the use of a gift or the delivery of a gift.

Some types of gifts can be purchased and used at the same time, and some types of gifts can be purchased, and then the viewer AU can use them at any point in time.

When the viewer AU gives a gift to the transmitter LV, the corresponding points are given to the transmitter LV.

When the viewer AU uses a gift, it may have an effect associated with the gift. For example, the special effects corresponding to the gift are respectively displayed on the user terminal 20 of the transmitter LV and the user terminal 30 (30a, 30b . . . ) of the viewers AU (AU1, AU2 . . . ).

In some embodiments, the gift database 314 may store the following in association with each other: gift IDs, awarding points (or reward points), and price points, but are not limited thereto. The gift ID may refer to the identification code that determines the gift. The awarding points may refer to the points given to the transmitter LV when the viewer AU gives a gift to the transmitter LV. The price points may refer to the equivalent remuneration that the viewer AU should pay for the use of the gift. The viewer AU can give the transmitter the gift by paying the equivalent remuneration points (i.e., price points) of the desired gift when viewing the live content provided by the transmitter LV. The payment of such equivalent remuneration points can be made through an appropriate electronic billing unit (not shown), e.g., through the payment of equivalent remuneration points from the viewer AU to the administrator. In some embodiments, bank transfers, credit card payments, etc., may also be used. The administrator can arbitrarily set the relationship between the awarding points and the price points. For example, it can be set that the awarding points are equal to the price points. In addition, it is also possible to set the value of the awarding points multiplied by a predetermined factor such as 1.2 as the price points, or the value of the awarding points plus the predetermined fee points as the price points.

Refer to FIG. 4D, which is a schematic view illustrating the data stored in the historical response database 330 according to an embodiment of the present disclosure. The historical response database 330 can be used to store messages related to response history. Specifically, in some embodiments, the historical response database 330 may store the following in association with each other: viewer ID, streaming ID, date, time, and history response, but is not limited thereto.

Since the streaming ID will have only one corresponding transmitter ID, the corresponding transmitter ID can be known through the data of the streaming ID, but in some embodiments, the historical response database 330 can store both the streaming ID and the transmitter ID. The viewer ID, the streaming ID, and the transmitter ID are basically the same as those described in FIG. 4A, that is, the viewer ID, the streaming ID, and the transmitter ID may be stored not only in the streaming database 310 in FIG. 4A, but also in the historical response database 330. The date may refer to information based on the date recorded at the moment when the viewer AU sends a message to the transmitter LV. Alternatively, the time may refer to the information based on the time recorded at the moment when the viewer AU sends a message to the transmitter LV, which may be, for example, recorded in the form of a 24-hour format. Alternatively, the history response may refer to the content of the message recorded when the viewer AU sends a message to the sender LV, which may specifically refer to a piece of string and symbol.

Refer to FIG. 4E, which is a schematic view illustrating the data stored in the parameter database 332 according to an embodiment of the present disclosure. The parameter database 332 can be used to store messages related to parameters. Specifically, in some embodiments, the parameter database 332 may store the following in association with each other: viewer ID, streaming ID, date, time, number of gifts, number of responses, etc., but is not limited thereto. In some embodiments, the number of gifts and the number of responses may be the number of gifts and the number of responses in a predetermined unit of time.

Since the streaming ID will have only one corresponding transmitter ID, the corresponding transmitter ID can be known through the data of the streaming ID, but in some embodiments, the parameter database 332 can store both the streaming ID and the transmitter ID. The viewer ID, the streaming ID, and the transmitter ID are basically the same as those described in FIG. 4A, that is, the viewer ID, the streaming ID, and the transmitter ID may be stored not only in the streaming database 310 in FIG. 4A, but also in the parameter database 332. In some embodiments, the date and time in the parameter database 332 are respectively the dates and times recorded when the viewer AU sends a message and/or gift to the transmitter LV. In some embodiments, the data may be recorded for a fixed period of time (for example, fixed recording for 1 minute), and then further judged whether the values of the number of gifts and/or the number of responses are zero, and if both are zero, the data is deleted from the database or the data is not stored directly (i.e., the parameter database 332 only stores the data with parameter records), otherwise, this data is stored in the parameter database 332. The number of gifts may be one of the parameters, and the number of responses may also be one of the parameters, and in addition, the parameter may also be the number of tokens used or the number of times of sharing and the like, but is not limited thereto. That is, the parameter database 332 can further store the number of tokens used or the number of times of sharing.

Refer to FIG. 4F, which is a schematic view illustrating the data stored in the topic score database 334 according to an embodiment of the present disclosure. The topic score database 334 can be used to store messages related to topic scores. Specifically, in some embodiments, the topic score database 334 may store the following in association with each other: transmitter ID, viewer ID, history topic, and score, but is not limited thereto.

The viewer ID and the transmitter ID are basically the same as those described in FIG. 4A, that is, the viewer ID and the transmitter ID may be stored not only in the streaming database 310 in FIG. 4A, but also in the topic score database 334. The history topic may refer to the type of various topics generated by the topic score processing unit 324, and it may be specifically a piece of string or a set of code. The score may refer to the score calculated from the topic score processing unit 324.

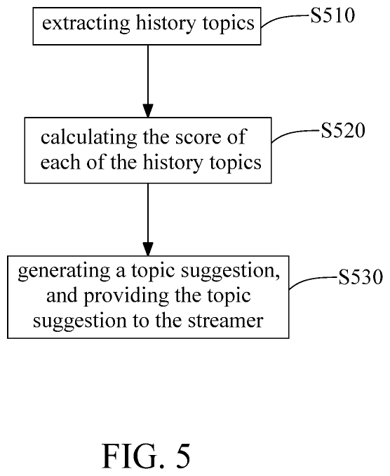

Refer to FIG. 5, which is a flowchart illustrating the method for facilitating streamer interaction with viewers according to an embodiment of the present disclosure, and the method includes steps S510, S520, and S530.

In step S510, history topics are extracted based on activity records in which viewers engage. Specifically, the data in the historical response database 330 may be processed through the history processing unit 320 in the server 10, and then the history topics are extracted through the topic score processing unit 324 in the server 10. The activity records in which the viewers engage may be records of various activities that the viewers engage in via the live-streaming platform. Specifically, they may include records of the viewer's responses and records of conversations between viewers and a streamer, or record of the streamer's performance content, but are not limited thereto.

The record of a viewer's response refers to the response content given by the viewer to the streamer, that is, the data stored in the historical response database 330. For example, when viewer A joins a live-streaming room of streamer A, the record of the viewer's response is the response content given by viewer A to streamer A. The record of the viewer's response can be all the responses recorded from the beginning to the present, or it can be a response content recorded for a period of time or a certain number. In some embodiments, the data fields of the record of the viewer's response may include the respondent (viewer), the response-receiver (streamer), response content, and response time points. For example, when viewer A gives streamer A a response content about “My dog is also very lively” at a time point A, the above content can be recorded at the same time as a record of the viewer's response. Certainly, the record of the viewer's response also includes the response content given by viewer A to streamer B or the response content given by viewer A to streamer C. In other words, the record of a viewer's response can include the viewer's response content to each streamer. In addition, the record of a viewer's response can be recorded in a time-series manner, that is, each response content given by the viewer to each streamer is recorded one by one in a time-ordered manner.

The record of conversations between viewers and a streamer refers to the interactive content of the streamer during the viewer engaging in the live-streaming room of the streamer. For example, after viewer A joins the live-streaming room of streamer A, the interactive content of streamer A starts to be recorded until the viewer A leaves the live-streaming room of streamer A. The record of the conversations between the viewers and the streamer can also be all the interactive content recorded from the beginning to the present, or it can be the interactive content recorded for a period of time or a certain number, and it can also be recorded in a time-series manner. Among them, the record of the conversations between the viewers and the streamer can textualize the interactive content of the streamer through a speech recognition unit, wherein the speech recognition unit may be a tool or an instruction set known to a person having ordinary knowledge in the art to which the present disclosure belongs, or it may be a function library that is known to a person having ordinary knowledge in the art to which the present disclosure belongs.

Step S510 can extract history topics based on activity records in which viewers engage, and it may specifically extract history topics through a machine learning model 370 or an artificial intelligence engine (not shown in the figure), that is, through step S510, the activity records recorded in time series can be converted into history topics recorded in time series. In some embodiments, the activity records in which the viewers engage can be summarized into corresponding topics through a trained supervised learning model. The trained supervised learning model refers to the use of various activity records that have completed various topic classification tags to train the model, so as to establish topic classification rules from the training data, so that the trained supervised learning model can follow the established topic classification rules to give corresponding topic classification tags after receiving the same or similar activity records. For example, when viewer A gives streamer A a response content about “My dog is also very lively” at a time point A, the trained supervised learning model is able to summarize the activity record into history topics such as pets or dogs.

In addition, in some embodiments, a large language model such as ChatGPT can also be used as an artificial intelligence engine to analyze the viewer's response records, and then extract topics from history based on the viewer's response records.

In step S520, the score of each of the history topics is calculated based on at least one parameter, and it may be specifically that the data in the parameter database 332 is processed through the parameter processing unit 322 in the server 10, and then the score is given to each history topic respectively through the topic score processing unit 324 in the server 10. The parameter may include the number of giving gifts by viewers, the number of tokens used by viewers, the number of responses from viewers, the tracking behavior of viewers, and the sharing behavior of viewers, etc., but is not limited thereto. In some embodiments, the score of each of the history topics can be calculated based on the number of responses from the viewers, for example, when the history topic is a pet, the corresponding score can be calculated based on the number of responses from the viewers. In some embodiments, the score of each of the history topics can be calculated based on the number of gifts given by the viewers, for example, when the history topic is sports, the corresponding score can be calculated based on the number of gifts given by the viewers. When multiple parameters are used simultaneously to calculate the score of each of the history topics, the weight value of each parameter can be set based on the designer's preferences or the platform administrator's priorities. In some embodiments, the score of the viewer AU relative to the transmitter LV for a certain topic at a certain point in time (or a certain time period) may be equal to the number of gifts, the number of gift amounts, or the number of responses that the viewer AU gives to the transmitter LV at the time point (or the time period).

In step S530, a topic suggestion is generated based on a history topic and a score corresponding to the history topic, and the topic suggestion is provided to the streamer. Specifically, the topic suggestion that is suitable for the viewers may be generated through the topic generation unit 326 in the server 10. Specifically, the topic suggestion can be selected from each history topic, the history topic with the highest or higher score is selected as the topic suggestion, and the topic suggestion is provided to the streamer. In some embodiments, because the history topic and the score corresponding to the history topic are different for each viewer, the topic suggestion may be tailored to different viewers.

In some embodiments, step S530 may also include detecting whether the current interactive topic is the same as the past history topic with the highest score. If the current interactive topic is different from the past history topic with the highest score, the past history topic with the highest score will be used as the topic suggestion. If the current interactive topic is the same as the past history topic with the highest score, the past history topic with the second highest score will be used as the topic suggestion, and the score of the history topic with the highest score in the topic score database 334 will be adjusted, for example, the score will be lowered as feedback.

Through the method of facilitating streamer interaction with the viewers as shown in FIG. 5, the viewer's preferred topic (i.e., generating a suitable topic suggestion) will be known, and the topic will be provided to the streamer, so that the streamer can use the topic to interact with the viewers in real time. In this way, the streamer can more effectively use the integrated information to directly interact with the viewers in real time with the appropriate topic.

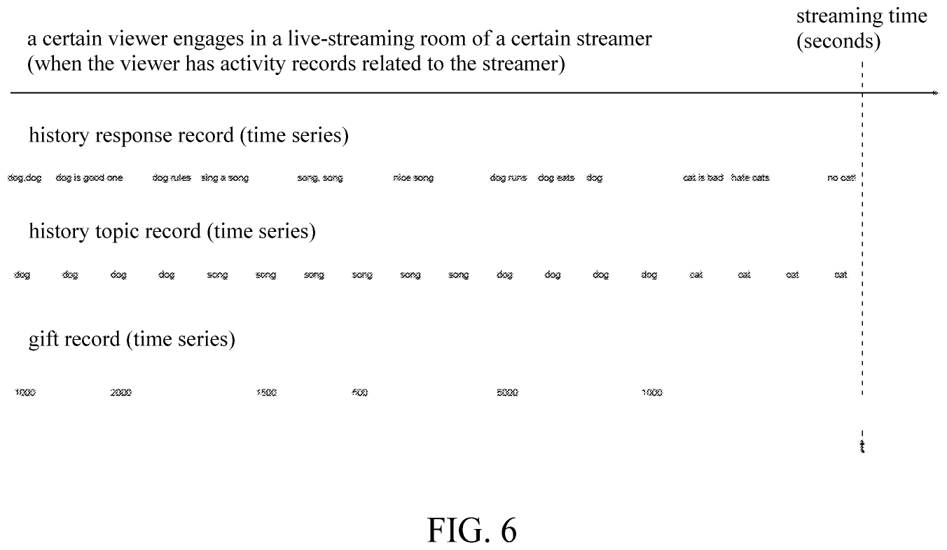

Refer to FIG. 6, which is a schematic view illustrating recording data in a time-series manner, with the horizontal axis being the streaming time (e.g., in seconds or minutes, but not limited thereto) according to an embodiment of the present disclosure. In some embodiments, the method shown in FIG. 6 may be used to record the data generated by a specific viewer in a live-streaming room of a specific streamer, which may include history response records, history topic records, and gift records, but is not limited thereto.

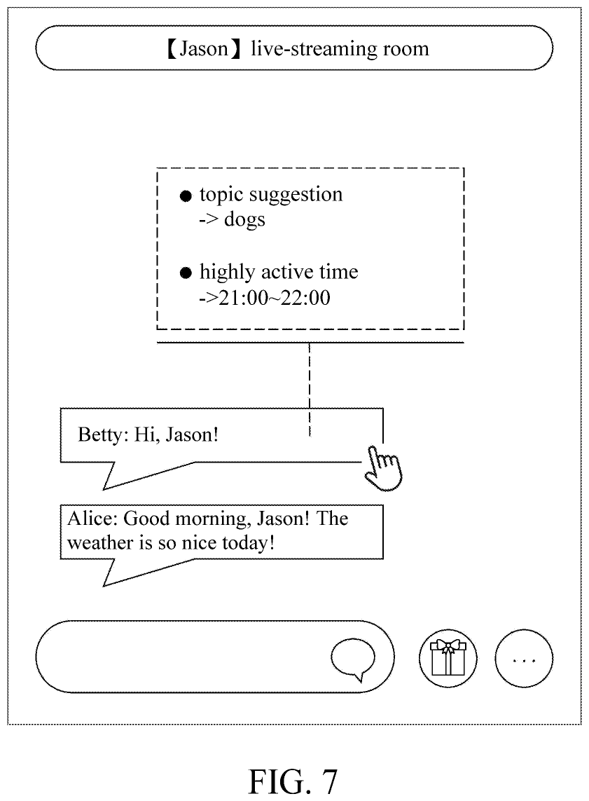

Refer to FIG. 7, which is a schematic view illustrating the display of a topic suggestion on a user interface according to an embodiment of the present disclosure, which may specifically refer to a schematic view of displaying a topic suggestion on the user terminal 20 of the transmitter LV (i.e., the streamer). Taking FIG. 7 as an example, when the streamer clicks on a specific viewer through the touch panel of the user terminal 20, the topic suggestion (i.e., the topic suggestion suitable for the viewer clicked by the streamer) generated through the topic generation unit 326 of the server 10 can be displayed. In this way, the streamer is able to interact with the viewer in real time based on the topic suggestion presented on the user interface of the user terminal 20. In some embodiments, the server 10 may also obtain other information (e.g., the viewer's highly active time on the live-streaming platform, but not limited thereto), and provide the information to the streamer together with the topic suggestion.

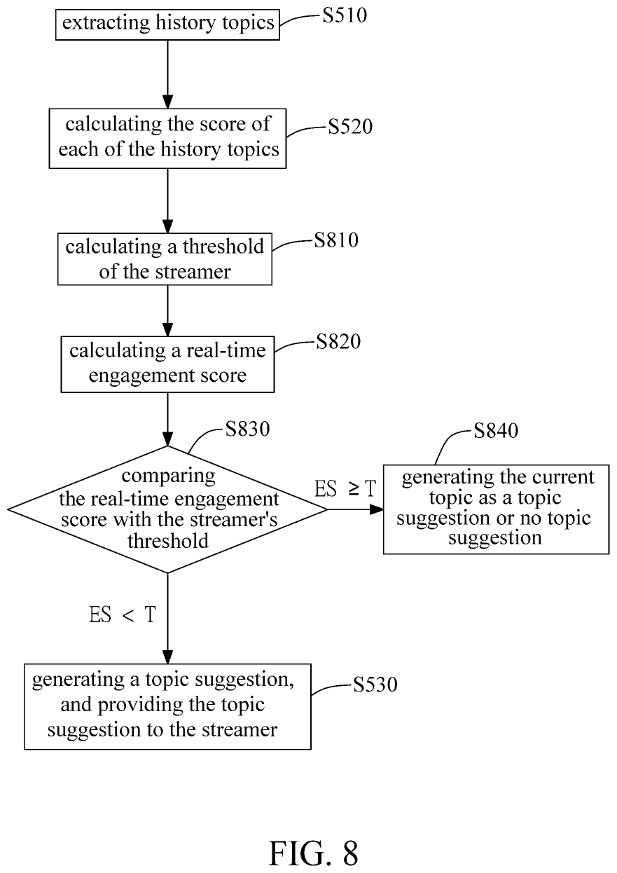

Refer to FIG. 8, which is a flow chart illustrating the method for facilitating streamer interaction with the viewers according to an embodiment of the present disclosure, and the method includes steps S510, S520, S530, S810, S820, S830, and S840, wherein the steps S510, S520, and S530 are basically the same as those shown in FIG. 1. That is, the method shown in FIG. 8 may include steps S510, S520, and S530 that are basically the same as those in FIG. 5, and further include steps S810, S820, S830, and S840.

In step S810, a threshold (or score threshold) of the streamer is calculated based on the level of the streamer. The level of the streamer can be differentiated according to the virtual tokens obtained by the streamer over a period of time, but is not limited thereto. For example, when the streamer obtains more virtual tokens within a period of time, it means the higher level of the streamer, and conversely, it means the lower the level of the streamer. The threshold of the streamer is basically positively correlated with the level of the streamer. That is to say, the higher the level of the streamer, the higher the threshold of the streamer, and conversely, it means the lower the threshold of the streamer. In some embodiments, the calculation of the threshold may be executed by a topic score processing unit 324 or a threshold calculation unit (not shown in the figure).

In step S820, a real-time engagement score ES of the viewer is calculated in real time based on at least one real-time parameter. Specifically, the real-time engagement score ES of the viewer may be calculated in real time based on real-time parameters such as the number of gifts given by viewers, the number of tokens used by viewers, the number of responses from viewers, the tracking behavior of viewers, and the sharing behavior of viewers, etc. The method of calculating the real-time engagement score ES may be basically the same as step S520, which may be specifically accomplished, for example, by calculating the average. That is, the focus of Step S820 is to calculate the real-time (i.e., current) engagement score. In some embodiments, the viewer's real-time engagement score ES may refer to the real-time engagement score ES between the viewer and a specific streamer, for example, the real-time engagement score ES between viewer A and streamer A, or the real-time engagement score ES between viewer A and streamer B.

In Step S830, the real-time engagement score ES is compared with the streamer's threshold T. Through step S830, it can be evaluated whether the viewer's engagement given to the streamer meets the streamer's expectations (or expectations from the streamer). Specifically, when the viewer's real-time engagement score ES is greater than or equal to the streamer's threshold T, that is, the viewer's engagement given to the streamer meets the streamer's expectations, step S840 is executed; when the viewer's real-time engagement score ES is less than the streamer's threshold T, the viewer's engagement given to the streamer fails to meet the streamer's expectations, step S530 is executed. In some embodiments, step S830 may be executed by a topic generation unit 326 or a score comparison unit (not shown in the figure) to further determine whether a topic suggestion is to be generated.

In step S840, the current topic is generated as a topic suggestion or no topic suggestion based on the current interactive content of the streamer. That is, the current interactive content does not need to be changed. Similarly, the current interactive content of the streamer can be textualized by the speech recognition unit, wherein the speech recognition unit may be a tool or an instruction set known to a person having ordinary knowledge in the art to which the present disclosure belongs, or it may be a function library that is known to a person having ordinary knowledge in the art to which the present disclosure belongs.

Through the method for helping the streamer interact with the viewers as shown in FIG. 8, it can not only help the streamer know the viewer's preferred topic and select the appropriate topic to interact with the viewer in real time, but also determine when it is necessary to provide the streamer with topic suggestions related to the viewer, and then provide the viewer's preferred topic to the streamer when the topic suggestions need to be given.

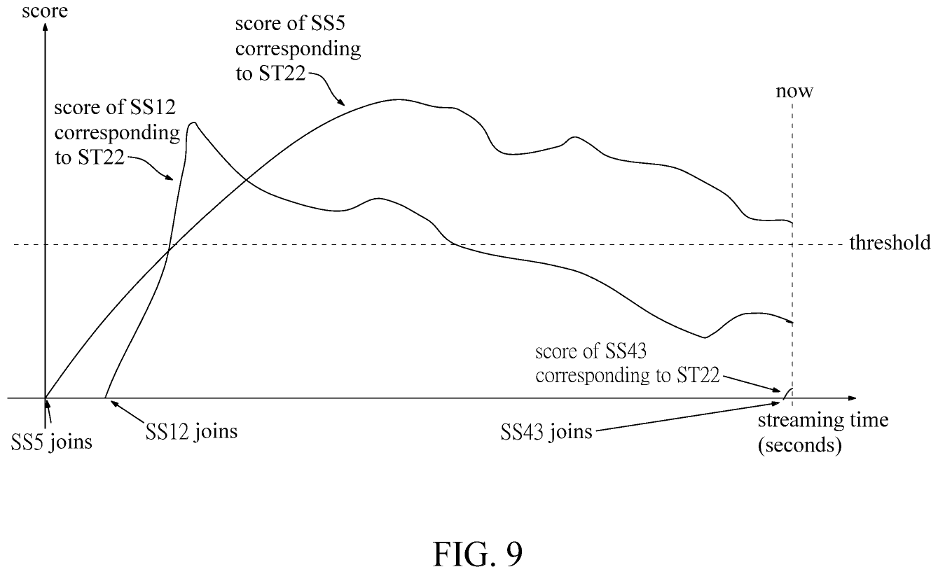

Refer to FIG. 9, which is a time series diagram illustrating the relative relationship between the viewer's score (or real-time engagement score ES) and the streamer's threshold according to an embodiment of the present disclosure, wherein the horizontal axis is the streaming time (in seconds) in the live-streaming room of the streamer, and the vertical axis is the value of the score between the viewer and the streamer. Taking FIG. 9 as an example, ST22 is used to refer to the streamer, and SS5, SS12, and SS43 are used to refer to different viewers, so the example shown in FIG. 9 can show that in the live-streaming room of the streamer (i.e., ST22), each viewer (i.e., SS5, SS12 and SS43) joins the live-streaming room of the streamer at different points in time, and the values of the scores between each viewer and the streamer are presented in the form of a time series diagram. In addition, the horizontal line in FIG. 9 can represent the threshold of the streamer, which is specifically a value calculated based on the level of the streamer (i.e., step S810 shown in FIG. 8). Therefore, the comparison results between each viewer's score and the streamer's threshold (i.e., greater than, equal to, or less than) can be known through FIG. 9, and then it is decided whether to generate a topic suggestion (i.e., step S530), or to generate the current topic suggestion as a topic suggestion or not to generate a topic suggestion (i.e., step S840). In some embodiments, the method can wait for the time for viewers to enter the live-streaming room to be greater than a predetermined or fixed set duration, and then the real-time engagement score ES of the viewer is compared with the threshold T of the streamer, and the set duration, for example, may be ten minutes, but not limited thereto. For example, it is normal for the viewer (SS43) in FIG. 9 to have a low real-time engagement score ES when he has just joined the live-streaming room.

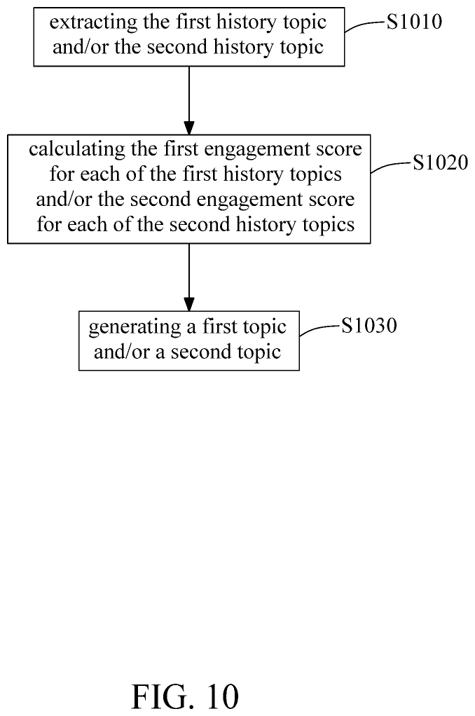

Refer to FIG. 10, which is a flow chart illustrating the method for facilitating streamer interaction with the viewers according to an embodiment of the present disclosure, and the method includes steps S1010, S1020, and S1030.

In step S1010, the first history topic and/or the second history topic are extracted, wherein the first history topic may refer to a history topic between a viewer and a specific streamer, and the second history topic may refer to a history topic between the viewer and other streamers. For example, when viewer A enters the live-streaming room of streamer A, the first history topic is the history topic between viewer A and streamer A, and the second history topic is the history topic between viewer A and other streamers (e.g., streamer B or streamer C).

The method of extracting the first history topic may be basically the same as that of step S510, except that the first history topic is extracted based on the first interaction record between the viewer and the specific streamer, wherein the first interaction record between the viewer and the specific streamer may include a record of the response given by the viewer to the specific streamer and a record of the conversation between the viewer and the specific streamer, but not limited thereto. In other words, when only the first interaction record between the viewer and a specific streamer is used to extract the first history topic, the history topic between the viewer and the specific streamer can be extracted more accurately. For example, when viewer A enters the live-streaming room of streamer A, the first history topic between viewer A and streamer A can be extracted based on the first interaction record between viewer A and streamer A.

The method of extracting the second history topic may be basically the same as that of step S510, except that the second history topic is extracted based on the second interaction record between the viewer and other streamers, wherein the second interaction record between the viewer and other streamers may include a record of the response given by the viewer to other streamers and a record of the conversation between the viewer and other streamers, but not limited thereto. In other words, when only the second interaction between the viewer and other streamers is used to extract the second history topic, the history topic between the viewer and other streamers can be additionally extracted. For example, when viewer A enters the live-streaming room of streamer A, the second history topic between viewer A and other streamers can be extracted based on the second interaction record between viewer A and other streamers (e.g., streamer B or streamer C).

In some embodiments, only the first history topic or only the second history topic may be extracted, or the first history topic and the second history topic may be extracted at the same time, and similarly, the first interaction record and/or the second interaction record recorded in time series can be respectively converted into the first history topic and/or the second history topic recorded in time series through step S1010.

In step S1020, the first engagement score for each of the first history topics and/or the second engagement score for each of the second history topics is calculated, wherein the method of calculating the first engagement score and the second engagement score may be basically the same as step S520.

The first engagement score for each of the first history topics can be calculated based on at least one first interaction parameter between the viewer and a specific streamer, and at least one first interaction parameter between the viewer and a specific streamer may include the number of gifts given by the viewer to a specific streamer, the number of tokens used by the viewer to a specific streamer, the number of responses given by the viewer to a specific streamer, the viewer's tracking behavior to a specific streamer, and the viewer's sharing behavior to a specific streamer, etc., but not limited thereto.

The second engagement score for each of the second history topics can be calculated based on at least one second interaction parameter between the viewer and other streamers, and at least one second interaction parameter between the viewer and other streamers can include the number of gifts given by the viewer to other streamers, the number of tokens used by the viewer to other streamers, the number of responses given by the viewer to other streamers, the viewer's tracking behavior to other streamers, and the viewer's sharing behavior to other streamers, etc., but not limited thereto.

In step S1030, a first topic (or first topic suggestion) and/or a second topic (or second topic suggestion) are generated, the first topic may be generated based on the first history topic and the first engagement score corresponding to the first history topic, and the second topic may be generated based on the second history topic and the second engagement score corresponding to the second history topic, wherein the method of generating the first topic and generating the second topic may be basically the same as step S530.

After the first and/or second topic is generated, the first or second topic can be optionally used as a topic suggestion, and the selected first or second topic is provided to the streamer.

By the method for helping the streamer interact with the viewers as shown in FIG. 10, the activity records between the viewer and the streamer can be used more effectively to generate the first topic and/or the second topic, so that the first topic and/or the second topic can be generated more accurately according to the needs of the streamer. For example, when viewer A enters the live-streaming room of streamer A, if there is already a certain activity record between viewer A and streamer A, the first topic can be generated as a topic suggestion, so that streamer A can use the first topic to interact with viewer A in real time. On the other hand, if there is no activity record between viewer A and streamer A, a second topic can be generated as a topic suggestion, so that streamer A can use the second topic to interact with viewer A in real time.

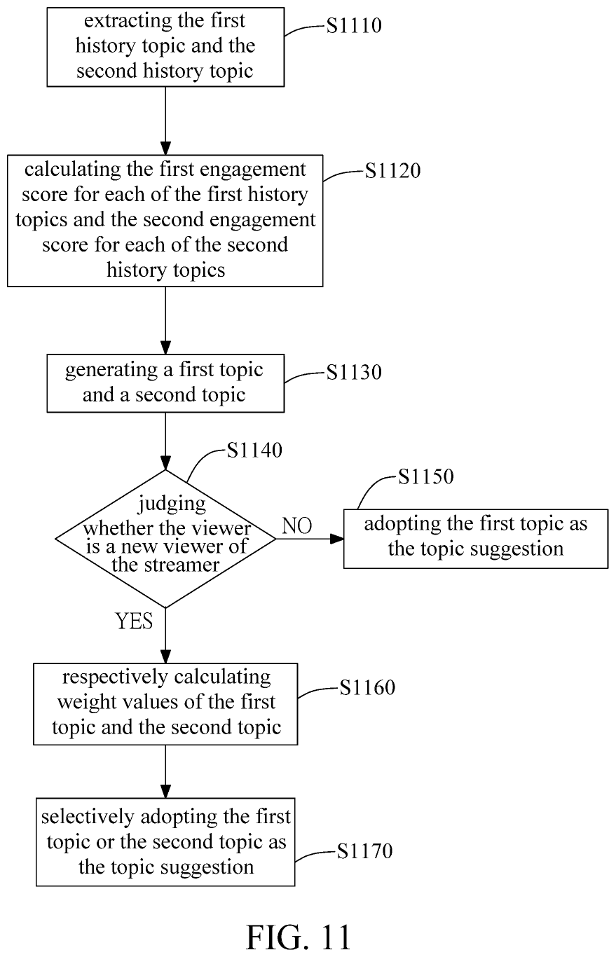

Refer to FIG. 11, which is a flow chart illustrating the method for helping the streamer interact with the viewers according to an embodiment of the present disclosure, and the method includes steps S1110, S1120, S1130, S1140, S1150, S1160, and S1170, wherein the steps S1110, S1120, and S1130 are basically the same as the steps S1010, S1020, and S1030 of FIG. 10, respectively. That is, the method shown in FIG. 4 can include basically the same steps as FIG. 10, and further includes steps S1140, S1150, S1160, and S1170.

In step S1140, it is judged whether the viewer is a new viewer of the streamer, and if the viewer is not a new viewer of the streamer, step S1150 is executed; if the viewer is a new viewer of the streamer, step S1160 is executed. In some embodiments, the method may judge whether the viewer is a new viewer of the streamer based on whether the viewer has ever joined the live-streaming room of the streamer. For example, when viewer A enters the live-streaming room of streamer A, if viewer A has entered the live-streaming room of streamer A, it is determined that viewer A is not a new viewer of streamer A. If viewer A has never entered the live-streaming room of streamer A, it is determined that viewer A is a new viewer of streamer A. In some embodiments, it may judge whether the viewer is a new viewer of the streamer based on the interaction duration between the viewer and the streamer. For example, when viewer A enters the live-streaming room of streamer A, if the interaction duration between viewer A and the streamer A is less than a certain time or a certain ratio, it is determined that viewer A is a new viewer of the streamer A. If the interaction duration between viewer A and streamer A is greater than or equal to a certain time or a certain ratio, it is determined that viewer A is not a new viewer of the streamer A. The certain time, for example, may be five minutes, but not limited thereto. The certain ratio refers to the interaction duration between the viewer and the specific streamer divided by the interaction duration between the viewer and all the streamers, and the certain ratio, for example, may be 0.05, but not limited thereto. In some embodiments, step S1140 may be executed by a topic generation unit 326 or a viewer recognition unit (not shown in the figure).

In step S1150, the first topic is adopted as the topic suggestion. Since the viewer is not a new viewer of the streamer, it means that there is a certain activity record between the viewer and the streamer, so the first topic generated has a certain reference or accuracy as a topic suggestion.

In step S1160, based on the interaction duration between the viewer and the specific streamer, a first weight value corresponding to the first topic and a second weight value corresponding to the second topic are respectively calculated. For example, as the interaction time (or history interaction duration) between viewer A and streamer A increases, the first weight value will be increased and the second weight value will be decreased. In some embodiments, the first weight value may be calculated according to the ratio of the viewer's interaction duration with the specific streamer on the live-streaming platform to the viewer's interaction duration with all streamers on the platform, and the second weight value may be calculated according to the ratio of the viewer's interaction duration with other streamers (compared with the specific streamer) on the live-streaming platform to the viewer's interaction duration with all streamers on the platform. In some embodiments, the interaction duration may be replaced with other interaction parameters, such as the number of gifts, the gift amounts, or the number of responses. In some embodiments, step S1160 may be executed by the topic score processing unit 324 or a weight calculation unit (not shown in the figure).

In step S1170, the first topic or the second topic is selectively adopted as the topic suggestion based on the first weight value corresponding to the first topic and the second weight value corresponding to the second topic. In some embodiments, a higher one may be selected from the first weight value and the second weight value as the topic suggestion. In some embodiments, the first engagement score of the first topic can be multiplied by the first weight value to obtain the first topic weighted score, and the second engagement score of the second topic can be multiplied by the second weight value to obtain the second topic weighted score, and the topic suggestion is selected from one of the first topic and the second topic according to the one with a higher score obtained by comparing the two. In some embodiments, step S1170 may be executed by the topic generation unit 326 or a topic selection unit (not shown in the figure).

By the method for facilitating streamer interaction with the viewers as shown in FIG. 11, the relationship between the viewer and the streamer (or history interaction relationship) can be determined, and then the more suitable one can be selected from the first topic and the second topic as the topic suggestion to be provided to the streamer, so that the streamer can use the more suitable topic suggestion to interact with the viewer in real time.

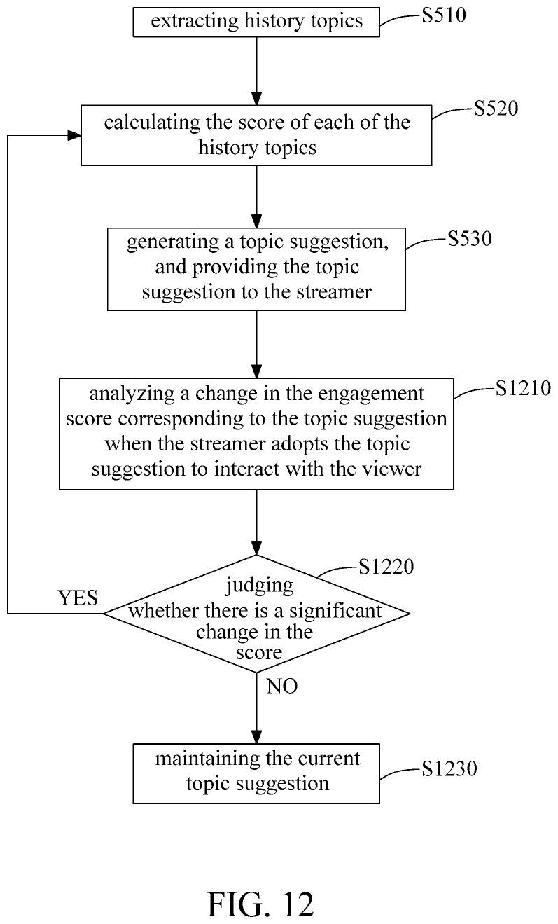

Refer to FIG. 12, which is a flow chart illustrating the method for facilitating streamer interaction with the viewers according to an embodiment of the present disclosure, and the method includes steps S510, S520, S530, S1210, S1220, and S1230, wherein the steps S510, S520, and S530 are basically the same as the steps in FIG. 5, respectively. That is, the method shown in FIG. 12 can include basically the same steps as in FIG. 5, and further includes steps S1210, S1220, and S1230.

In step S1210, when the streamer adopts the topic suggestion to interact with the viewer, a change in the score corresponding to the topic suggestion is analyzed. In some embodiments, when the topic corresponding to the interactive content of the streamer is the same as the topic suggestion, the change in the score corresponding to the topic suggestion is analyzed, so as to observe whether the score corresponding to the topic suggestion increases or decreases. In some embodiments, the analysis (step S1210) may be executed by the trend analysis unit 328.

In step S1220, it is judged whether there is a significant change in the score (which may be executed by the trend analysis unit 328). After analyzing the change in the score corresponding to the topic suggestion (i.e., step S1210), the change in the score of the viewer corresponding to the topic suggestion is determined, where the change may be a significant increase, a significant decrease, and no significant change, but not limited thereto. Specifically, determining the change of the score can be to extract the real-time engagement score before adoption before the topic of the streamer's interactive content is the same as the topic suggestion. Similarly, after the topic of the streamer's interactive content is the same as the topic suggestion, the real-time engagement score after adoption is extracted. In this way, the difference between the pre-adoption real-time engagement score and the post-adoption real-time engagement score (i.e., the post-adoption real-time engagement score minus the pre-adoption real-time engagement score) can be calculated first, and then the ratio between the difference and the pre-adoption real-time engagement score can be calculated, and the ratio can be used as a reference value to evaluate whether there is a significant change in the score. In some embodiments, a significant increase may mean a percentage increase in the value of the score over a period of time (e.g., a score increases by more than 10% in three minutes); a significant decrease may mean a percentage decrease in the value of the score over a period of time (e.g., a score decreases by more than 10% in three minutes); no significant change may mean that the score changes less than a certain percentage over a period of time (e.g., the score fails to increase by more than and fails to decrease by more than 10% in three minutes). In some embodiments, it can be judged whether there is a significant change by the rate of change of the real-time engagement score ES before and after the streamer adopts the topic suggestion. The real-time engagement score ES can be a composite real-time engagement score calculated by using the real-time engagement score ES of all viewers, or it can be a real-time engagement score ES for a certain viewer.

When there is a significant change in the score, a first judgment result can be generated, and the score for a history topic that is the same as the topic suggestion can be adjusted based on the first judgment result. In some embodiments, when it is determined that the score has significantly increased through step S1220, a positive feedback value can be generated, thereby increasing the score of the history topic that is the same as the topic suggestion. Also, when it is determined that the score has significantly decreased through step S1220, a negative feedback can be generated, thereby decreasing the score of the history topic that is the same as the topic suggestion, and the topic suggestion can be regenerated based on the adjusted score (i.e., after adjusting the score of the history topic, step S530 can be executed continuously). When there is no significant change in the score, a second judgment result can be generated, and based on the second judgment result, a decision can be made to maintain the current topic suggestion (i.e., step S1230) without adjusting the score for the history topic.

By the method for facilitating streamer interaction with the viewer as shown in FIG. 12, it can be examined whether the generated topic suggestion can help the streamer interact with the viewer in real time, and can further decide whether to adjust the score of the history topic that is the same as the topic suggestion and/or maintain the current topic suggestion based on the change of score, so that the method for facilitating streamer interaction with the viewer can further provide the streamer with the topic suggestion that is more suitable for the viewer after evaluating the previous topic suggestion.

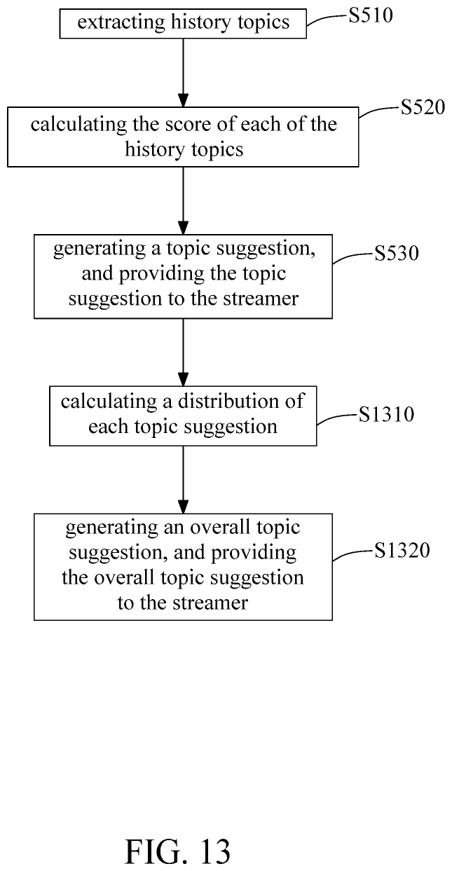

Refer to FIG. 13, which is a flow chart illustrating the method for facilitating streamer interaction with the viewers according to an embodiment of the present disclosure, and the method includes steps S510, S520, S530, S1310, and S1320, wherein the steps S510, S520, and S530 are basically the same as the steps in FIG. 5, respectively. That is, the method shown in FIG. 13 can include basically the same steps as in FIG. 5, and further include steps S1310 and S1320.

In step S1310, a distribution of each topic suggestion is calculated based on the topic suggestions of a plurality of viewers in the live streaming of the streamer. For example, when there are viewer A, viewer B, and viewer C in the live-streaming room of streamer A, steps S510, S520, and S530 can respectively generate topic suggestions for viewer A, viewer B, and viewer C, and the distribution of topic suggestions for each viewer (i.e., viewer A, viewer B, and viewer C) can be further calculated. In some embodiments, the distribution may include individual scores, corresponding viewer numbers, or frequency of occurrence of each topic suggestion.

In step S1320, an overall topic suggestion is generated based on the distribution, and the overall topic suggestion is provided to the streamer, wherein the overall topic suggestion may be generated in a way such as the highest occurrence rate, the highest score, or the highest relevance, but is not limited thereto. The highest occurrence rate is the topic suggestion with the highest number of occurrences among the topic suggestions corresponding to each viewer. The highest score is the topic suggestion with the highest score corresponding to each topic suggestion among the topic suggestions corresponding to each viewer. The highest relevance refers to the topic suggestion with the highest total score after calculating the total score of each topic suggestion, and then adding up the topic suggestion with the highest score among the topic suggestions. For example, when there are viewer A, viewer B, and viewer C in the live-streaming room of streamer A, topic suggestions for viewer A, viewer B, and viewer C (pets, sports, and sports, respectively) can be respectively generated through steps S510, S520, and S530, and the corresponding scores of each topic suggestion are respectively 100, 50, and 80. In this case, if the method of highest occurrence rate is used to generate the overall topic suggestion, the result is sports (2 occurrences); if the method of the highest score is used to generate the overall topic suggestion, the result is pets (score of 100); if the method of the highest relevance is used to generate the overall topic suggestion, the result is sports (total score of 130).

By the method for facilitating streamer interaction with the viewer as shown in FIG. 13, the overall topic suggestion can be generated based on the topic suggestions of each viewer in the live-streaming room, so that the streamer can interact with the plurality of viewers in real time more effectively. In addition, because the streamer can use the overall topic suggestion to interact with individual viewers in real time, this also avoids the sense of oppression (or invasion of privacy) caused by the streamer using specific topic suggestions to interact with the viewer in real time.

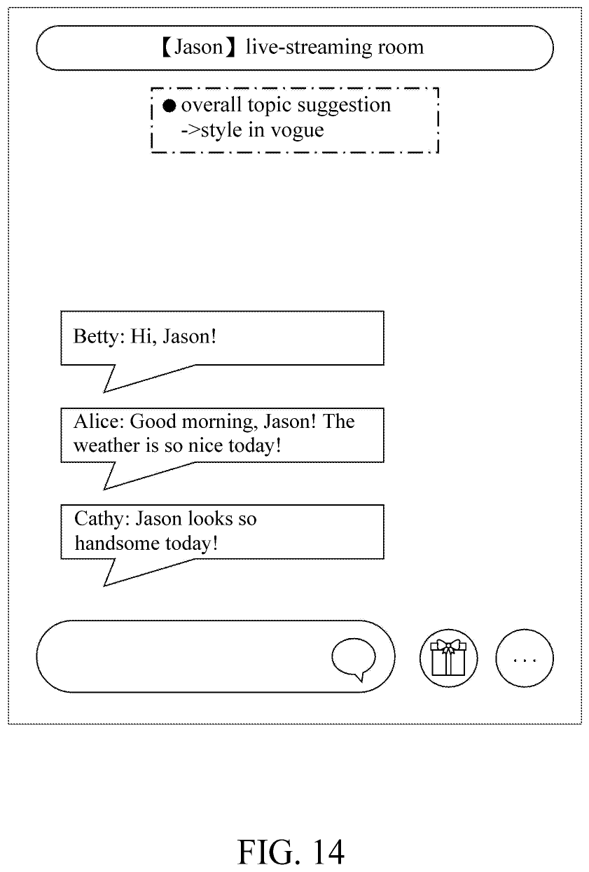

Refer to FIG. 14, which is a schematic view illustrating the display of the topic suggestion on the user interface according to an embodiment of the present disclosure, which may specifically refer to a schematic view of displaying the topic suggestion on the user terminal 20 of the transmitter LV (i.e., the streamer). Taking FIG. 14 as an example, the overall topic suggestion (i.e., the topic suggestion suitable for the overall viewers in the live-streaming room) generated by the topic generation unit 326 of the server 10 can be displayed. In this way, the streamer is able to interact with the viewer in the live-streaming room in real time based on the overall topic suggestion presented on the user interface of the user terminal 20. In some embodiments, the overall topic suggestion may be displayed all the time. In other embodiments, the overall topic suggestion may be hidden until the streamer needs to refer to the overall topic suggestion, and then the overall topic suggestion is displayed through the mode of active clicking by the streamer or the mode of automatic judgment by the server 10. In some embodiments, the server 10 may continuously or periodically calculate the overall real-time engagement score and makes an overall topic suggestion when it detects a significant decrease in the overall real-time engagement score (e.g., the decline slope exceeds a certain set value). The overall real-time engagement score can be calculated by using the real-time engagement score of individual viewers, for example, by using an average or by weighting the contribution value of each viewer on the platform (e.g., history gift amounts).

In some embodiments, the steps of the above-described method for facilitating streamer interaction with the viewer may be stored in a computer-readable storage medium, the computer-readable storage medium, for example, may be a hard disk, a compact disk, a floppy disk, a USB flash drive, or a database accessible by a network, but not limited thereto. After a computer loads a code or instruction set stored in the computer-readable storage medium and executes it, the above-described method for facilitating streamer interaction with the viewer can be achieved.

In some embodiments, the steps of the above-described method for facilitating streamer interaction with the viewer may be accomplished by a computing device. The computing device includes at least one processing unit and at least one storage unit, wherein the at least one processing unit may be any processor known to a person having ordinary knowledge in the art to which the present disclosure belongs, and the at least one storage unit may be any memory known to a person having ordinary knowledge in the art to which the present disclosure belongs. The at least one storage unit is used to store the code or instruction set of the above-described method for facilitating streamer interaction with the viewer, and the at least one processing unit is capable of achieving the above-described method for facilitating streamer interaction with the viewer after executing the code or instruction set.

The present disclosure has been further described through the above-mentioned embodiments and attached drawings. However, a person having ordinary knowledge in the art to which the present invention belongs can still make various modifications and changes without departing from the scope and spirit of claims of the present disclosure. Therefore, the protection scope of the present disclosure should still be defined by the claims, and should not be limited by the content disclosed in the specification.

What is claimed is:

1. A method for facilitating a streamer interaction with a viewer, suitable for providing a topic suggestion with respect to the viewer to the streamer via a live-streaming platform executed by a computing device, the method comprising:
extracting a history topic based on an activity record of the viewer;
calculating a score of each of the history topics based on at least one parameter; and
generating the topic suggestion based on the history topic and the score corresponding to the history topic, and providing the topic suggestion to the streamer.

2. The method according to claim 1, wherein generating the topic suggestion based on the history topic and the score corresponding to the history topic comprises:
calculating a threshold of the streamer based on the level of the streamer;
calculating a real-time engagement score of the viewer in real time based on at least one real-time parameter;
comparing the real-time engagement score with the threshold;
generating the topic suggestion based on the history topic and the score corresponding to the history topic when the real-time engagement score is less than the threshold; and
generating a current topic as the topic suggestion or no topic suggestion based on the current interactive content of the streamer when the real-time engagement score is greater than or equal to the threshold.

3. The method according to claim 1, wherein:
the history topic is a first history topic, configured to be extracted based on a first interaction record between the viewer and the streamer;
the score is a first engagement score, configured to be calculated based on at least one first interaction parameter between the viewer and the streamer; and
the topic suggestion is a first topic, configured to be generated based on the first history topic and the first engagement score corresponding to the first history topic.

4. The method according to claim 1, wherein:
the history topic is a second history topic, configured to be extracted based on a second interaction record between the viewer and other streamers;
the score is a second engagement score, configured to be calculated based on at least one second interaction parameter between the viewer and other streamers; and
the topic suggestion is a second topic, configured to be generated based on the second history topic and the second engagement score corresponding to the second history topic.

5. The method according to claim 1, wherein:
the history topic comprises a first history topic and a second history topic, the first history topic is configured to be extracted based on a first interaction record between the viewer and the streamer, and the second history topic is configured to be extracted based on a second interaction record between the viewer and other streamers;
the score comprises a first engagement score and a second engagement score, the first engagement score is configured to be calculated based on at least one first interaction parameter between the viewer and the streamer, and the second engagement score is configured to be calculated based on at least one second interaction parameter between the viewer and other streamers; and
the topic suggestion comprises a first topic and a second topic, the first topic is configured to be generated based on the first history topic and the first engagement score corresponding to the first history topic, and the second topic is configured to be generated based on the second history topic and the second engagement score corresponding to the second history topic.

6. The method according to claim 5, further comprising:
judging whether the viewer is a new viewer of the streamer;
if the viewer is not the new viewer of the streamer, the first topic is adopted as the topic suggestion; and
if the viewer is the new viewer of the streamer, the first topic or the second topic is selectively adopted as the topic suggestion.

7. The method according to claim 6, wherein selectively adopting the first topic or the second topic as the topic suggestion comprises:
based on an interaction duration between the viewer and the streamer, respectively calculating a first weight value corresponding to the first topic and a second weight value corresponding to the second topic; and
based on the first weight value corresponding to the first topic and the second weight value corresponding to the second topic, selectively adopting the first topic or the second topic as the topic suggestion.

8. The method according to claim 1, further comprising:
analyzing a change in the score corresponding to the topic suggestion when the streamer adopts the topic suggestion to interact with the viewer.

9. The method according to claim 1, further comprising:
calculating a distribution of each topic suggestion based on the topic suggestions of a plurality of viewers in the live streaming of the streamer; and
generating an overall topic suggestion based on the distribution, and the overall topic suggestion is provided to the streamer.

10. A computing device for facilitating a streamer interaction with a viewer, suitable for providing a topic suggestion with respect to the viewer to the streamer in a live-streaming platform executed thereby, the computing device comprising:
at least one processing unit; and
at least one storage unit, storing a code;
wherein after executing the code, the at least one processing unit is capable of executing the following steps:
the steps of the method for facilitating a streamer interaction with the viewer according to claim 1.

11. The computing device according to claim 10, wherein generating the topic suggestion based on the history topic and the score corresponding to the history topic comprises:
calculating a threshold of the streamer based on the level of the streamer;
calculating a real-time engagement score of the viewer in real time based on at least one real-time parameter;
comparing the real-time engagement score with the threshold;
generating the topic suggestion based on the history topic and the score corresponding to the history topic when the real-time engagement score is less than the threshold; and
generating a current topic as the topic suggestion or no topic suggestion based on the current interactive content of the streamer when the real-time engagement score is greater than or equal to the threshold.

12. The computing device according to claim 10, wherein:
the history topic is a first history topic, configured to be extracted based on a first interaction record between the viewer and the streamer;
the score is a first engagement score, configured to be calculated based on at least one first interaction parameter between the viewer and the streamer; and
the topic suggestion is a first topic, configured to be generated based on the first history topic and the first engagement score corresponding to the first history topic.

13. The computing device according to claim 10, wherein:
the history topic is a second history topic, configured to be extracted based on a second interaction record between the viewer and other streamers;
the score is a second engagement score, configured to be calculated based on at least one second interaction parameter between the viewer and other streamers; and
the topic suggestion is a second topic, configured to be generated based on the second history topic and the second engagement score corresponding to the second history topic.

14. The computing device according to claim 10, wherein:
the history topic comprises a first history topic and a second history topic, the first history topic is configured to be extracted based on a first interaction record between the viewer and the streamer, and the second history topic is configured to be extracted based on a second interaction record between the viewer and other streamers;
the score comprises a first engagement score and a second engagement score, the first engagement score is configured to be calculated based on at least one first interaction parameter between the viewer and the streamer, and the second engagement score is configured to be calculated based on at least one second interaction parameter between the viewer and other streamers; and
the topic suggestion comprises a first topic and a second topic, the first topic is configured to be generated based on the first history topic and the first engagement score corresponding to the first history topic, and the second topic is configured to be generated based on the second history topic and the second engagement score corresponding to the second history topic.

15. The computing device according to claim 14, wherein the at least one processing unit is further capable of executing the following steps:
judging whether the viewer is a new viewer of the streamer;
if the viewer is not the new viewer of the streamer, the first topic is adopted as the topic suggestion; and
if the viewer is the new viewer of the streamer, the first topic or the second topic is selectively adopted as the topic suggestion.

16. A computer-readable storage medium for facilitating a streamer interaction with a viewer, after a computer loads a code stored in the computer-readable storage medium and executes it, the method for facilitating the streamer interaction with the viewer according to claim 1 is capable of being achieved.

17. The computer-readable storage medium according to claim 16, wherein generating the topic suggestion based on the history topic and the score corresponding to the history topic comprises:
calculating a threshold of the streamer based on the level of the streamer;
calculating a real-time engagement score of the viewer in real time based on at least one real-time parameter;
comparing the real-time engagement score with the threshold;
generating the topic suggestion based on the history topic and the score corresponding to the history topic when the real-time engagement score is less than the threshold; and
generating a current topic as the topic suggestion or no topic suggestion based on the current interactive content of the streamer when the real-time engagement score is greater than or equal to the threshold.

18. The computer-readable storage medium according to claim 16, wherein:
the history topic is a first history topic, configured to be extracted based on a first interaction record between the viewer and the streamer;
the score is a first engagement score, configured to be calculated based on at least one first interaction parameter between the viewer and the streamer; and
the topic suggestion is a first topic, configured to be generated based on the first history topic and the first engagement score corresponding to the first history topic.

19. The computer-readable storage medium according to claim 16, wherein:
the history topic is a second history topic, configured to be extracted based on a second interaction record between the viewer and other streamers;
the score is a second engagement score, configured to be calculated based on at least one second interaction parameter between the viewer and other streamers; and
the topic suggestion is a second topic, configured to be generated based on the second history topic and the second engagement score corresponding to the second history topic.

20. The computer-readable storage medium according to claim 16, wherein:
the history topic comprises a first history topic and a second history topic, the first history topic is configured to be extracted based on a first interaction record between the viewer and the streamer, and the second history topic is configured to be extracted based on a second interaction record between the viewer and other streamers;
the score comprises a first engagement score and a second engagement score, the first engagement score is configured to be calculated based on at least one first interaction parameter between the viewer and the streamer, and the second engagement score is configured to be calculated based on at least one second interaction parameter between the viewer and other streamers; and
the topic suggestion comprises a first topic and a second topic, the first topic is configured to be generated based on the first history topic and the first engagement score corresponding to the first history topic, and the second topic is configured to be generated based on the second history topic and the second engagement score corresponding to the second history topic.
